(19) United States
(12) Patent Application Publication
(10) Pub. No.: US 2005/0081893 A1
(43) Pub. Date: Apr. 21, 2005

(54) Method of cleaning surfaces in contact with a fluid flow

(76) Inventor: Bjarne Nilsen, Saetre (NO)

Correspondence Address: Bracewell & Patterson, L.L.P., P.O. Box 61389, Houston, TX, 77208-1389, US

(21) Appl. No.: 10/625,995

(22) Filed: Jul. 24, 2003

(30) Foreign Application Priority Data
Jul. 24, 2002 (GB) 0217255.9

(51) Int. Cl. B08B 3/00

(52) U.S. Cl. 134/34

(57) ABSTRACT

A method of cleaning a light-transmissive and/or light reflective surface in contact with a fluid flow comprising particles extracted or generated in an oil extraction installation is described. The method comprises providing a source of flushing fluid comprising ozone, providing means for flushing the surface with the flushing fluid, and operating flushing means such that the surface is flushed with the flushing fluid. Apparatus for optically monitoring characteristics of such a fluid flow, the apparatus being adapted to take advantage of the aforementioned method, is also described.

### CROSS-REFERENCE TO RELATED APPLICATION

This application claims the benefit of United Kingdom Patent Application No. 0217255.9, filed on Jul. 24, 2002, which hereby is incorporated by reference in its entirety.

### BACKGROUND OF THE INVENTION

1. Technical Field of the Invention

The present invention relates to cleaning light-transmissive and/or light reflective surfaces in contact with fluid flow.

2. Background of the Invention

Optical devices are employed in the fluid extraction business to measure characteristics of the fluid, such as the proportion of water/oil/contaminants in a liquid flowing in a pipe. Such devices rely on light passing through windows in the wall of the pipe from which an analysis of the liquid is derived. However, a significant problem with such devices is that the transparent surface of the windows becomes contaminated, thus reducing the transparency of the windows such that the optical device fails to function correctly.

Two possible solutions to this problem are proposed in UK Application No. 0102825.7, which discloses an apparatus having methanol nozzles positioned inside a pipe for flushing away deposits on windows with high pressure methanol, and windows having an uneven inner surface, so as to reduce the available contact area for any particles to attach to. However, while these two measures are sufficient to deal with any small sized organic molecules, they do not always allow effective removal of any large organic molecules due to the strong adherence of such molecules to window surfaces. Thus the build up of such molecules on the windows of the optical device can prove to be a serious problem where the fluid flow concerned can be expected to contain a significant number of such molecules.

### SUMMARY OF THE INVENTION

According to one aspect of the present invention, there is provided a method of cleaning a light-transmissive and/or light reflective surface in contact with a fluid flow comprising particles extracted or generated in an oil extraction installation, said method comprising providing a source of flushing fluid comprising ozone, providing means for flushing said surface with said flushing fluid, and operating said flushing means such that said surface is flushed with said flushing fluid.

According to another aspect of the present invention, there is provided apparatus for optically monitoring characteristics of a fluid flow comprising particles extracted or generated in an oil extraction installation, the apparatus comprising:
a duct for receiving the fluid flow;
light generating means adjacent the duct for transmitting light into the fluid flow via a light-transmissive part of the duct;
light-responsive detection means for receiving light from the light generating means that has passed through the fluid flow;
means for processing signals produced by the detection means so as to provide data relating to the fluid flow;
flushing means adapted to flush the light-transmissive part of the duct with a flushing fluid comprising ozone; and
means for generating said ozone.

It is known in the water purification field that ozone can be used to clean glass and plastic from organic material, such that visibility through the glass is not reduced. For example devices exist for cleaning potable water where a fluorescent tube creates ozone, which creates bubbles at atmospheric pressure which, as a beneficial by product, cleans the glass (the main objective for the device is, of course, to kill bacteria). Ozone in these applications forms bubbles, and the polluted fresh (i.e. not salty) water is thereby decontaminated. However, while the use of ozone for the cleaning of water and of surfaces such as glass in water systems is well known, the use of ozone to clean transparent surfaces in contact with the fluids extracted by production wells, such as oil, is not.

Thus the method and apparatus of the present invention make use of properties of ozone to provide a cleaning mechanism that is chemical and/or physical. Chemically, the ozone can break certain bonds in molecules which adhere to the aforementioned transparent and/or reflective surfaces such that the resultant products are much more easily flushed away.

Preferably the flushing fluid comprises water saturated with ozone at high-pressure, eg. 50 bar. This enables the products resulting from the chemical breaking of the bonds of the molecules to be physically flushed away from the transparent and/or reflective surfaces by the high-pressure water (i.e. a washing effect). As previously noted, the adherence of large organic molecules is so strong that, without these molecules being first broken down into smaller parts, high pressure water on its own would not on its own be able to adequately clean the surfaces—i.e. the chemical breakdown of the molecules' bonds must be effected first to enable the water flushing process to remove the contaminants.

Preferably the water is saturated with ozone at a pressure that is substantially greater than the fluid pressure at the surfaces to be cleaned (i.e. than the fluid pressure in the pipe), such that when the flushing operation is carried out the drop in pressure will result in ozone coming out of the solution in the form of ozone bubbles in the water. This enhances the removal of the products of bond-broken molecules, in a similar manner to the “abrasive” effects of the bubbles in a Jacuzzi bath.

Preferably the temperature of the water is also raised. This has a multiplicity of benefits, including a greater volume of ozone dissolved in the saturated solution for a given volume of water, resulting in more bubbles and a greater vibration amplitude of the water and ozone molecules, thus further enhancing both the physical (washing effect) and chemical cleaning efficiency.

In the cleaning system described above, it would also be desirable to have a system for inspection and measurement of the optical parameters of the window. Preferably, apparatus according to the present invention therefore further comprises means for monitoring the optical characteristics of said light-transmissive part comprising:
light reflecting means adapted to reflect a proportion of the light passing through the light-transmissive part;
light-responsive detection means for receiving said reflected light; and
means for processing the data produced by said reflected light detection means so as to produce data relating to said light-transmissive part, the flushing means being further adapted to flush the light reflecting means with a flushing fluid comprising ozone.

With such an apparatus a light beam can be passed through the light-transmissive part, and reflected back through it by the light reflecting means. The cleanliness of the light-transmissive part can thus be determined and this information used to control the periodicity of application of the flushing fluid. Furthermore, the flushing means is operative to clean the light reflecting means at the same time as the light-transmissive part such that neither the optical monitoring of the fluid flow nor of the apparatus itself is affected by the build up of large organic molecules.

### BRIEF DESCRIPTION OF THE DRAWINGS

Embodiments of the present invention will now be described, by way of example, with reference to FIG. 1 to 5, in which;

FIG. 1 is a schematic view of an embodiment of apparatus according to the present invention;

FIG. 2 is a schematic view showing part of FIG. 1 in greater detail;

FIG. 3 is a schematic view showing a flushing fluid generating arrangement;

FIG. 4 is a schematic view of an alternative embodiment of apparatus according to the present invention; and

FIG. 5 is a schematic view showing part of Fig.4 in greater detail.

### DESCRIPTION OF THE PREFERRED EMBODIMENT

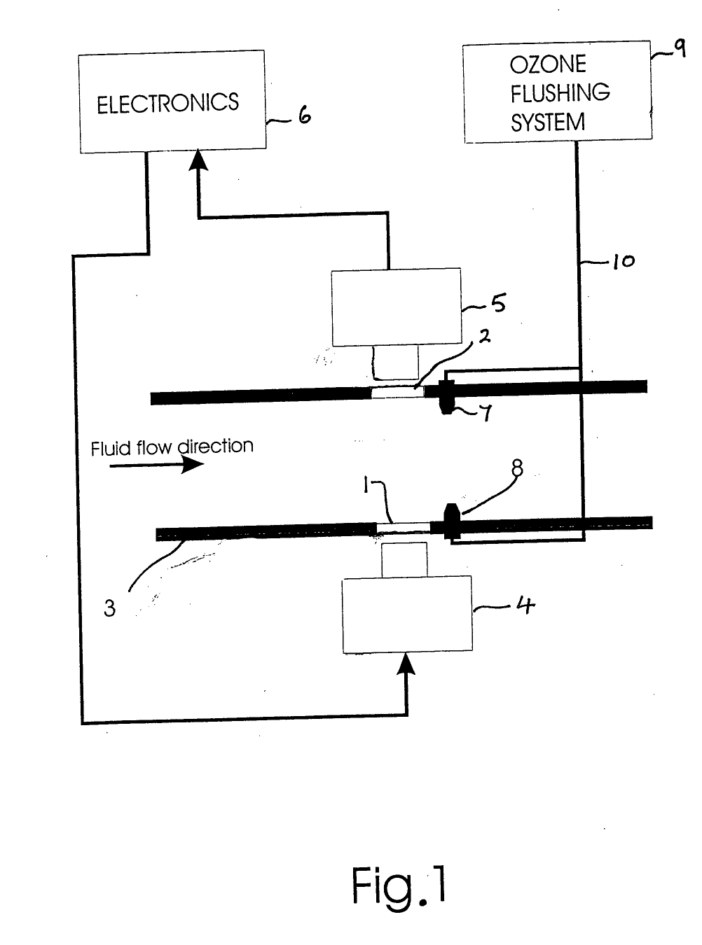

FIG. 1 shows an apparatus for optically monitoring characteristics of a fluid flow is shown comprising two optical windows 1 and 2, typically of diamond or sapphire construction and which may be coated with a non-stick coating, embedded in opposing sides of the wall of a duct 3 which may constitute part of an oil well fluid pipe 3. A light source 4 is positioned outside the duct adjacent window 1, and a camera 5 with a built in frame grabber is positioned outside the duct adjacent window 2, the light source 4 and camera 5 being both connected to an electronics unit 6.

In order to prevent organic compounds from building-up on the windows 1 and 2, the apparatus further comprises nozzles 7 and 8 positioned on the inside of the pipe 3 down stream of the windows 1 and 2, and a generator 9 for generating a flushing fluid comprising a ozone-saturated water, the flushing fluid generator being connected to the nozzles 7 and 8 by a supply line 10.

In operation of the apparatus, the light source 4 generates a beam of light that passes through window 1, the fluid in the pipe and window 2 to the camera 5, allowing a series of frames to be captured. The electronics unit 6 has a multiplicity of functions. One function is to provide stabilised electric power to the light source 4. A second function is to receive a grabbed frame from the camera 5 and analyse it to monitor the fluid inside the pipe for solid particles and dispersed oil droplets, using for example the technique referred to herein as the “Jorin” technique and described in International Patent Application Publication No. WO 00/46586 and the paper “On-line determination of particle size and concentration (solids and oil) using ViPA Analyser” by Dr Kami Nezhali, et al, presented at the “7^{th} Annual International Forum Production Separation Systems”, 23 May 2000, Oslo.

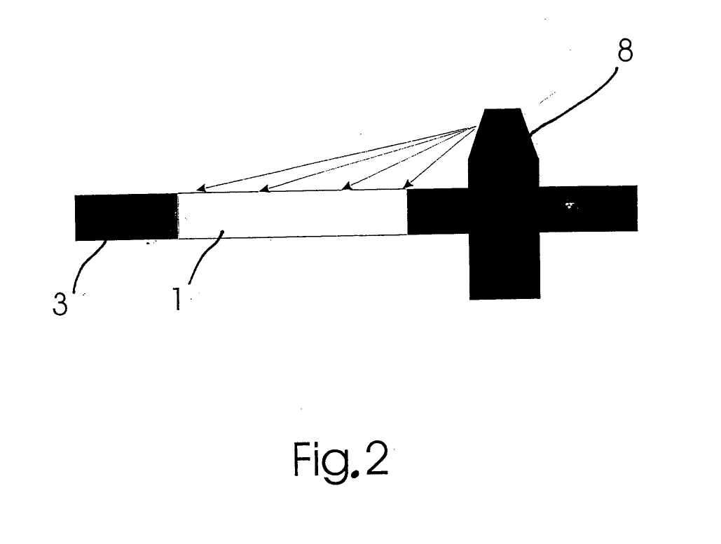

FIG. 2 shows, in greater detail, the method of cleaning the windows 1 and 2, in which cleaning is effected by spraying ozone saturated water at high pressure onto the surfaces of the windows 1 and 2 from nozzles 7 and 8.

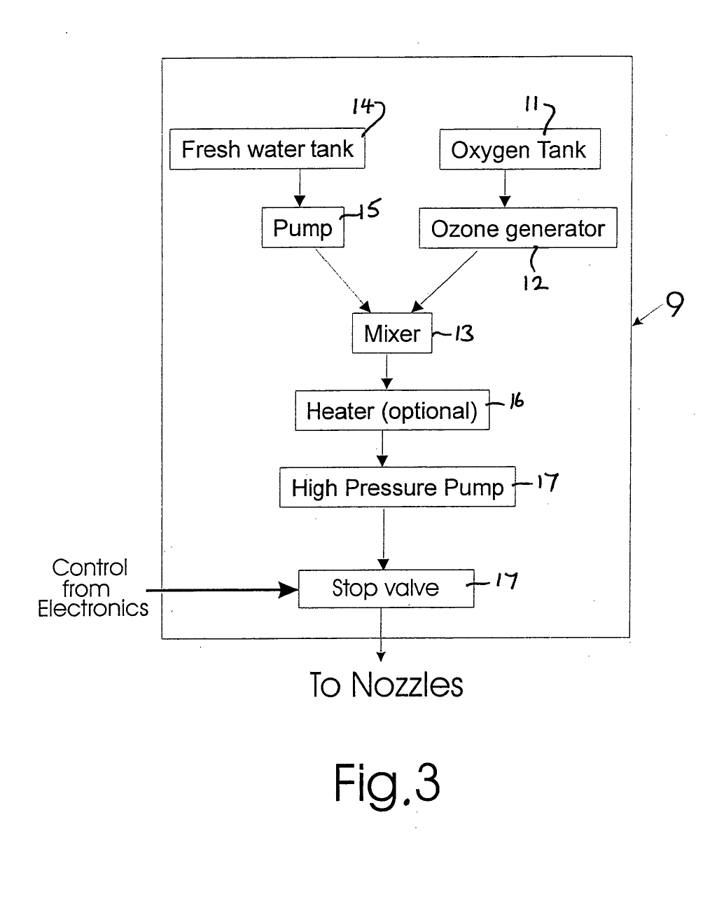

FIG. 3 shows a suitable flushing fluid generating arrangement, as carried out by the flushing fluid generator 9. Oxygen is fed from an oxygen tank 11 to an ozone generator 12, the oxygen and ozone mixture being fed to a mixer 13 which mixes the ozone with water pumped from a fresh water tank 14 by a pump 15. Once the water has become saturated with ozone the solution can then be heated, if required, by a heater 16 and is then fed to a high pressure pump 17. The output of the high pressure pump is fed via a stop valve 18 to the nozzles 7 and 8, the stop valve being under the control of the electronics unit 6.

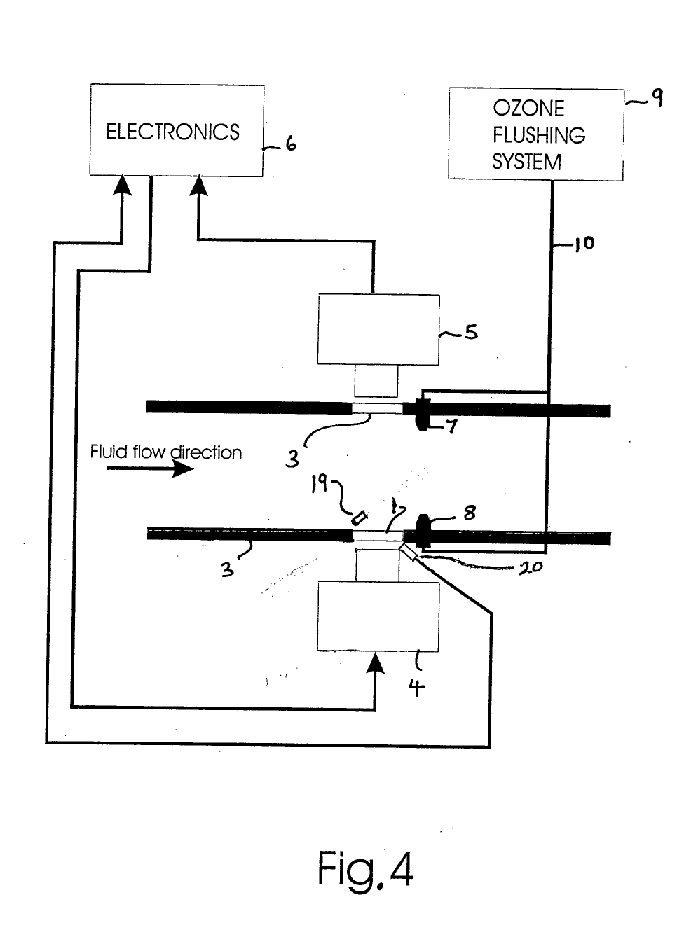

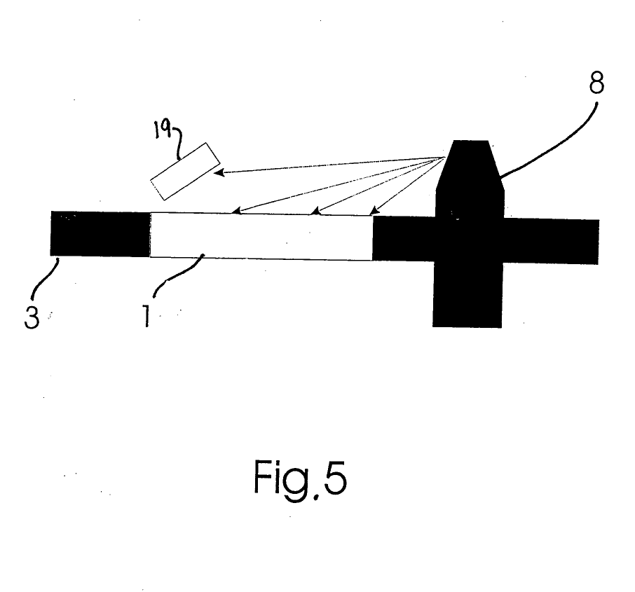

FIGS. 4 and 5 show an alternative apparatus, in which parts corresponding to like parts used in the previous embodiment are given the same reference numerals, and in which it is further possible to assess when the windows need cleaning. This is achieved by the addition to the previous embodiment of a small mirror 19, attached to the duct wall interior and positioned to reflect a small proportion of the light from the light source 4 which has passed through the window 1 back through window 1 to a light sensor 20 positioned outside the duct adjacent window 1. As shown in FIG. 5, the mirror is furthermore positioned so that the fluid sprayed from nozzle 8 also cleans its reflective surface. The light sensor 20 is connected to the electronics unit 6, which performs the additional function of receiving the output of the light sensor 20. As the window 1 and/or mirror 19 become contaminated, the amount of reflected light reaching the light sensor, and thus the light sensor's output, reduces. When the light sensor output falls bellow a predetermined level, the electronics unit 6 activates the ozone cleaning process via operation of stop valve 18.

The apparatus described above is suitable for use in both sub-sea and “topside” locations. Due to the provision of means for effectively keeping the windows clean, the apparatus also makes the use of Jorin fluid monitoring technique practical and attractive in well fluid extraction systems, whereas previously the technique was seriously limited by the rapid contamination of the optical elements and therefore impractical.

Although the embodiments illustrated in the accompanying Figures all make use of two opposed windows, a single window method could equally be used in which the second window 2 is replaced by an ozone cleaned mirror adapted to reflect the light from the light source 4 back to a camera mounted adjacent to the light source, rather than on the opposite side of the duct.

1. A method of cleaning a light-transmissive and/or light reflective surface in contact with a fluid flow comprising particles extracted or generated in an oil extraction installation, said method comprising:
providing a source of flushing fluid comprising ozone;
providing means for flushing said surface with said flushing fluid; and operating said flushing means such that said surface is flushed with said flushing fluid.

2. A method according to claim 1, wherein said flushing fluid comprises a flushing liquid/ozone mixture, said source of flushing fluid comprising a reservoir of said flushing liquid and means for generating ozone and mixing the same with said flushing liquid prior to the flushing operation.

3. A method according to claim 2, wherein said flushing liquid is an ozone solvent such that on mixing said flushing liquid with ozone a flushing liquid/ozone solution is formed.

4. A method according to claim 3, wherein the flushing liquid is water.

5. A method according to claim 3, wherein the flushing means ejects the flushing liquid/ozone solution at high pressure.

6. A method according to claim 3, wherein the flushing liquid is saturated with ozone.

7. A method according to claim 6, wherein the step of saturating the flushing liquid with ozone is carried out at a higher pressure than that of the fluid flow in contact with the surface to be cleaned, such that when the step of flushing said surface or surfaces is carried out the drop in pressure results in ozone coming out of solution.

8. A method according to claim 1, wherein the method is for cleaning one or more light-transmissive and/or reflective components of an apparatus for optically monitoring characteristics of said fluid flow.

9. Apparatus for optically monitoring characteristics of a fluid flow comprising particles extracted or generated in an oil extraction installation, the apparatus comprising:
a duct for receiving the fluid flow;
light generating means adjacent the duct for transmitting light into the fluid flow via a light-transmissive part of the duct;
light-responsive detection means for receiving light from the light generating means that has passed through the fluid flow;
means for processing signals produced by the detection means so as to provide data relating to the fluid flow;
flushing means adapted to flush the light-transmissive part of the duct with a flushing fluid comprising ozone; and
means for generating said ozone.

10. Apparatus according to claim 7, further comprising means for monitoring the optical characteristics of said light-transmissive part comprising:
light reflecting means adapted to reflect a proportion of the light passing through the light-transmissive part;
light-responsive detection means for receiving said reflected light; and
means for processing the data produced by said reflected light detection means so as to produce data relating to said light-transmissive part, wherein the flushing means is further adapted to flush the light reflecting means with flushing fluid.
